(19) United States
(12) Patent Application Publication
(10) Pub. No.: US 2021/0300782 A1
(43) Pub. Date: Sep. 30, 2021

(54) SYSTEM AND METHOD FOR RECOVERING TIN AND/OR PALLADIUM FROM A COLLOIDAL SUSPENSION

(71) Applicant: Advanced Research Solutions, LLC, Ann Arbor, MI (US)

(72) Inventor: Paul Cook, Ann Arbor, MI (US)

(73) Assignee: Advanced Research Solutions, LLC, Ann Arbor, MI (US)

(21) Appl. No.: 17/201,161

(22) Filed: Mar. 15, 2021

Related U.S. Application Data
(60) Provisional application No. 62/993,963, filed on Mar. 24, 2020.

(51) Int. Cl. C01G 55/00; C01G 19/00; C02F 9/00; B01D 21/26; B01D 21/01

(52) U.S. Cl. CPC C01G 55/001; C01G 19/00; C02F 1/5245; B01D 21/262; B01D 21/01; C02F 9/00

(57) ABSTRACT

A process for efficiently and economically recovering palladium from a colloidal suspension of tin and palladium involves the use of centrifugation to obtain a sediment enriched in tin and a centrifugate enriched in palladium. An aggregating agent is employed to enhance separation during centrifugation, and ion exchange may be employed to recover palladium from the centrifugate.

### CROSS-REFERENCE TO RELATED APPLICATIONS

This application claims priority to provisional Application No. 62/993,963, filed on Mar. 24, 2020 and is incorporated herein by reference in its entirety.

### FIELD OF THE DISCLOSURE

This disclosure generally relates to a system and process for recovering tin and palladium from rinse water after conventional activation of plastic substrates using a colloidal type activator.

### BACKGROUND OF THE DISCLOSURE

A rinse wash may be used in the treatment of a material or surfaces, such as non-conductive surfaces that have been activated with palladium deposits to promote electroless or electrolytic deposition of metal. Rinse washes may include or, as part of a rinsing process, may become infused with palladium particles. Tin compounds are typically added to stabilize the palladium in a desired valance conducive to achieving effective and economical activation of the non-conductive surface being treated. It is desirable to recover the palladium and tin separately.

### SUMMARY OF THE INVENTION

A system for recovering tin and/or palladium from rinse water is provided. The system includes a device operable to add a chemical to the rinse water, wherein the chemical causes tin particles and/or palladium particles to form in the rinse water, a centrifuge device operable to separate components of the rinse water based upon density and form a solidified portion, and a precipitate recovery device operable to extract the solidified portion from the rinse water.

In some embodiments, the precipitate recovery device includes an ion exchange resin device.

A process for recovering tin and/or palladium from rinse water is provided. The process includes adding a chemical to the rinse water, wherein the chemical causes colloidally dispersed tin and/or palladium to precipitate from the rinse water and from a slurry. The process further includes, separating components in the resulting slurry based upon density. The process further includes, within a precipitate recovery device, recovering the tin and/or the palladium from the slurry.

In some embodiments, extracting the recovering palladium includes utilizing an ion exchange resin device.

In some aspects of this disclosure, a process is provided for recovering palladium and tin from a colloidal suspension using centrifugation. The process includes adding a precipitating agent to the colloidal suspension before or during centrifugation. In other embodiments, further enrichment (or concentration) of the palladium can be achieved using an ion exchange resin.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 illustrates an exemplary system useful for recovering tin and palladium from rinse water, in accordance with the present disclosure.

FIG. 2 illustrates an alternative exemplary system useful for recovering tin and palladium from rinse water, in accordance with the present disclosure.

### DETAILED DESCRIPTION

A system and process for recovering tin and/or palladium from rinse water after conventional activation of plastic substrates using a colloidal type activator are provided. In an exemplary first step of the process, a precipitation, cementation or aggregation agent (collectively referred as precipitation agents) is added to the rinse water to precipitate the tin or both tin and palladium. As used herein, unless otherwise stated, precipitation refers to physical and/or chemical changes to palladium and/or tin species in a colloidal suspension which facilitate separation by filtration, centrifugation and/or sedimentation. As used herein, unless otherwise indicated, separate and separation refer to operations that produce an enriched palladium phase or stream depleted of tin and an enriched tin phase or stream depleted of palladium. Selective precipitation of tin can be caused by adjusting the pH of the rinse water (e.g., from 1 to 9, preferably from 1 to 4) leaving palladium predominately as a colloidal dispersion. In an exemplary second step of the process, the rinse water is processed through a centrifuge, wherein the precipitated tin is collected as a sediment from a clarified supernatant portion of the rinse water.

The tin precipitate is mostly particles less than 1 micron and typically less than 0.5 microns. This is a fine mud-like consistency that is difficult to remove by known filtration methods. A disk stack centrifuge can be used to remove these fine particles with high efficiency.

The disk stack centrifuge allows continuous operation and expels the fine precipitate in a concentrated condition. This precipitate is thus separated from the main water portion of the rinse water. This recovered precipitate contains tin and possibly some palladium that can be recovered by known methods such as pyrometallurgical, electrolytic plating and others. As the sediment and supernatant are continuously separated, ionic palladium in the supernatant can be efficiently recovered using a suitable ion exchange resin.

Therefore, the separation of the solid/liquid phase allows the total recovery of the palladium and tin from the process and saves valuable and scarce resources.

One advantageous aspect of an embodiment of the disclosed process includes optimizing use of an ion exchange resin to recover palladium. If the rinse water, filled with small tin particles which act like a fine mud is channeled directly to the ion exchange resin, the resin quickly plugs/clogs with tin particles. This quickly fouls or renders useless the resin and reduces the amount of palladium that is recovered. The disclosed process can employ centrifugation to separate the predominantly palladium-containing supernatant from the predominantly tin-containing sediment, with the palladium-containing supernatant sent to the ion exchange resin for subsequent recovery from the resin.

In another aspect of the disclosed processes, a precipitating agent, cementation agent or aggregation agent is added to the rinse water to precipitate both tin and palladium, and the resulting slurry is centrifuged to form a predominantly tin precipitate phase or stream and a predominantly palladium precipitate phase or stream mechanically separated by a centrifuge based on density of the respective precipitates.

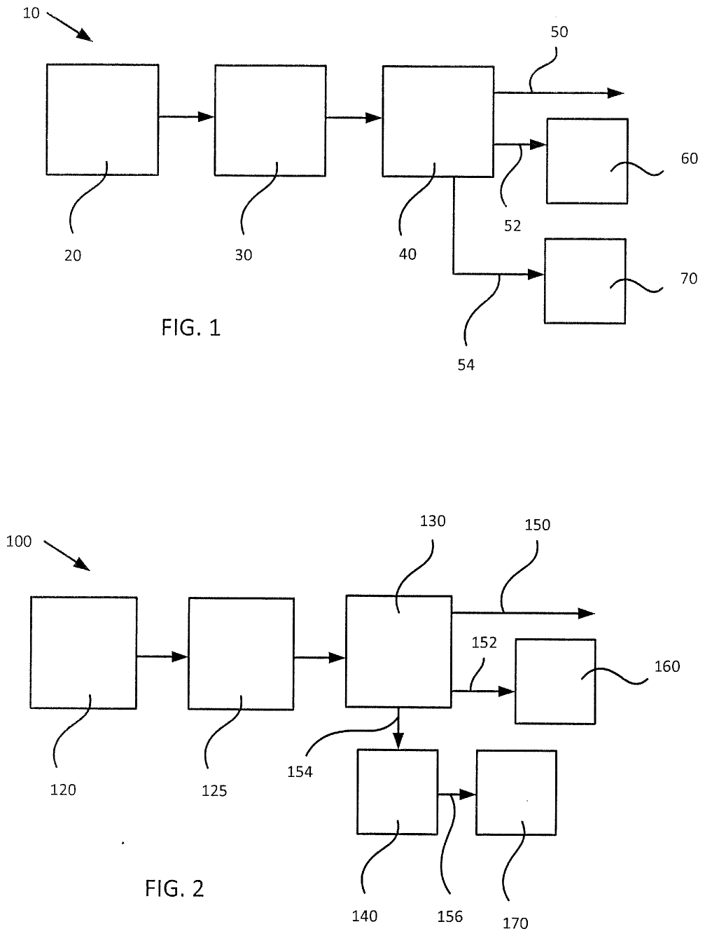

FIG. 1 illustrates an exemplary system 10 useful for recovering tin and palladium from rinse water. Illustrated system 10 includes an unprocessed rinse water source 20, centrifuge device 30, precipitate recovery device 40, tin storage tank 60, and palladium storage tank 70. Unprocessed rinse water flows from the rinse water source 20 to the centrifuge device 30. Therein, a precipitation agent (e.g., aggregation or cementation agent) is added to the rinse water, and a spinning, centrifugal operation is applied to the rinse water solution, and, as a result, components of the unprocessed rinse water are separated according to density. A flow of stratified rinse water is provided to precipitate recovery device 40, which removes the tin (and possibly some palladium) precipitates from the stratified rinse water. As a result, three distinct flows can be created: a clarified rinse water flow 50 containing colloidally dispersed palladium, a tin precipitate flow 52, and a palladium precipitate flow 54. The clarified rinse water flow 50 may be processed, reused, or disposed of in different ways, depending upon the properties of the clarified rinse water flow 50. The tin particulate flow 52 is provided to the tin storage tank 60. The palladium particulate flow 54 is provided to the palladium storage tank 70.

FIG. 2 illustrates an alternative exemplary system 100 useful for recovering tin and palladium from rinse water. System 100 is illustrated including unprocessed rinse water source 120, precipitation agent additive device 125, centrifuge device 130, ion exchange resin device 140, tin storage tank 160, and palladium storage tank 170. Unprocessed rinse water flows from the rinse water source 20 to the precipitation agent additive device 25, wherein a precipitation agent is added to the rinse water. Particulates flows from the device 25 to the centrifuge device 130, wherein a spinning, centrifugal operation is applied to the rinse water solution, and, as a result, components of the unprocessed rinse water are separated according to density.

Centrifuge device 130 may include a device such as the GEA Clarifier FSD 1-06-107, a device which may continuously centrifuge a flow of a colloidal liquid, separate the colloidal liquid into a liquid phase and one or more solid phases, and provide out flows of the separated materials.

A flow of clarified rinse water 150 is provided which may be treated, reused, or disposed of. A flow of tin precipitate 152 is provided and flows to the tin storage tank 160. The supernatant can be provided to the ion exchange resin device 140, which collects colloidally dispersed palladium particles.

A system and process for recovering tin and palladium from a rinse water flow is provided. It will be appreciated that similar rinse flows and similar liquids may similarly be processed, and particulate materials recovered.

It is believed that rinse material used in electroplating and electroless plating processes employing a palladium activator are often colloidal suspensions, wherein the palladium and tin exist in the form of very small particles that cannot be separated from the liquid medium in which they are dispersed using filtration and/or sedimentation techniques. The colloidal palladium may be present in the form of ionic complexes or metal clusters. Regardless of the form in which the palladium exists, the methods disclosed herein involve preferentially precipitating tin and subsequently or concurrently centrifuging the resulting slurry to obtain a sediment that is richer in tin than the original colloidal suspension and a centrifugate or supernatant liquid richer in palladium relative to the original colloidal suspension.

In certain aspects of the process, the colloidal suspension can be chemically or physically treated (e.g., heated) to precipitate or aggregate the colloidal tin particles into larger non-colloidal particles. Cementation agents that can be used to aggregate colloidal tin particles include metal powders, for example, iron and/or aluminum metal powders. Other chemicals that can be used for precipitating or aggregating colloidal tin include neutralizing agents such as sodium hydroxide. Other reported aggregating/precipitating agents for colloidal ammonia include calcium hypochlorite and zine powder. A pH change in the range of 1-9 and more preferably 1-4 is believed effective to preferentially precipitate tin while preferentially leaving palladium in the colloidal form. When aluminum precipitation agent is used, it is desirable to adjust the pH in the range 6-10.

In certain other aspects of the disclosed process, further separation or enrichment of palladium in the supernatant is contacted with an ion exchange resin. The palladium is selectively concentrated in the ion exchange resin and can be recovered using conventional methods such as by chemical regeneration or leaching of the ashed resin, followed by chemical or electrolytic reduction to reclaim palladium in a metallic form. Suitable ion exchange resins include basic anionic exchange resins, such as those having quaternary ammonium or phosphonium groups attached to the polymeric resin backbone.

While the best modes for carrying out the disclosure have been described in detail, those familiar with the art to which this disclosure relates will recognize various alternative designs and embodiments for practicing the disclosure within the scope of the appended claims.

What is claimed is:

1. A system for recovering tin and palladium from rinse water, comprising:
a precipitation agent addition device operable to add a precipitation agent to the rinse water, wherein the precipitation agent causes tin to precipitate;
a centrifuge device operable to separate components of the rinse water into a tin-rich sediment and a palladium rich supernatant; and
an ionic resin exchange device operable to recover palladium from the supernatant.

2. A process for recovering tin and palladium from rinse water, comprising:
within a precipitation agent addition device, adding a precipitation agent to the rinse water, wherein the precipitation agent causes tin to precipitate from the rinse water to form a slurry;
within a centrifuge device, separating components of the slurry based upon density;
forming a solidified portion of the tin and a solidified portion of the palladium; and
within a precipitate recovery device, recovering the solidified portion of the tin and the solidified portion of the palladium.

3. The process of claim 2, wherein addition of the precipitation agent causes both tin and palladium to precipitate, and centrifugation separates the tin precipitate from the palladium precipitate.

4. The process of claim 2, wherein extracting the solidified portion of the palladium from the rinse water includes utilizing an ion exchange resin device.

5. A method of separating palladium and tin from a colloidal suspension in which the palladium and tin are dispersed, comprising:
adding a precipitation agent to the colloidal suspension to cause the colloidally dispersed tin to precipitate and form a slurry; and
centrifuging the slurry to obtain a sediment that is richer in tin as compared with the colloidal suspension and a centrifugate that is richer in palladium as compared with the colloidal suspension.

6. The process of claim 5, wherein the precipitation agent is a metal powder. The process of claim 6, wherein the metal powder is iron powder.

8. The process of claim 6, wherein the precipitation agent is calcium hypochlorite.

9. The process of claim 6, wherein the precipitation agent is an alkali neutralizing agent.

10. The process of claim 9, wherein the alkali neutralizing agent is sodium hydroxide.

11. The process of claim 5, wherein the palladium is predominantly in the centrifugate, and further comprising contacting the centrifugate with an ion exchange resin in which palladium is concentrated for subsequent recovery from the ion exchange resin.

12. The process of claim 5, wherein the addition of precipitation agent results in a change in pH, with the resulting pH being from 1-9.

13. The process of claim 5, wherein the addition of precipitation agent results a change in pH, with the resulting pH being from 1-4.

14. The process of claim 5, wherein the precipitation agent is aluminum powder, and the pH of the colloidal suspension is adjusted to the range of 6-10

15. The process of claim 5, wherein addition of the precipitation agent causes both tin and palladium to precipitate, and centrifugation separates the tin precipitate from the palladium precipitate.
